(19) United States
(12) Patent Application Publication
(10) Pub. No.: US 2010/0138784 A1
(43) Pub. Date: Jun. 3, 2010

(54) MULTITASKING VIEWS FOR SMALL SCREEN DEVICES

(75) Inventor: Ashley Colley, Oulu (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/325,032

(22) Filed: Nov. 28, 2008

(51) Int. Cl. G06F 3/048; G06F 3/14

(52) U.S. Cl. 715/810; 715/864

(57) ABSTRACT

A system and method that includes providing content items to be displayed on a display of a device, determining a relevance of each content item with respect to each other content item, and organizing the content items on the display of the device along a scattered continuum, wherein more contextually relevant content is located closer to a center area of the display and less contextually relevant content is located away from the center area.

### BACKGROUND

1. Field

The aspects of the disclosed embodiments generally relate to user interfaces and more particularly to a user interface for presenting views in multi-tasking environments.

2. Brief Description of Related Developments

Multitasking generally involves users using several applications at the same time on a device. User will commonly switch between different active applications on a device. In many cases, switching between active applications can include clicking on an application tab on the screen, or selecting the desired application from a list of active applications. Switching between applications is an increasing need in mobile devices, driven particularly by the increased usage of internet based services. It will be the case that the user's overall experience is not defined by the usage of one application or service but by the combined usage of several such services - each service being used in a bursty way (i.e. used for a few minutes, then user does something else before returning to the original service).

In small screen devices there is typically a limited about of space in the user interface. Thus, it is generally not possible to show each of the open applications (such as the task bar in Windows). Navigation to any kind of view containing open applications can be considered blind navigation, as the user does not know what they will find there. When multitasking in a small screen device, users are forced to remember which applications are open and being used. Also, users, in these multi-tasking environments, will often accidentally or otherwise, close applications before they have completed their usage. This problem is completely un-addressed by conventional multitasking solutions.

Users should not have to navigate through the main menu, perform even deeper navigation, or make a text based search in order to find the required application or content item.

Other multitasking solutions tend to separate applications from the rest of navigation in a user interface. Some of these solutions include for example, the Windows™ task bar, Apple™expose, and Nokia s60™ taskswapper. The basis of these solutions is to separate open applications from the rest of the navigation in the user interface.

It would be advantageous to be able to easily identify open and closed states of applications while multi-tasking as well as not having to navigate through a main menu to find active applications during multi-tasking. It would also be advantageous to avoid having to navigate through a tree of applications to find a required content item or have to make a text based search to find a content item in a multi-tasking environment.

### SUMMARY

The aspects of the disclosed embodiments are directed to include at least a method, apparatus, user interface and computer program product. In one embodiment, the method includes providing content items to be displayed on a display of a device, determining a relevance of each content item with respect to each other content item, and organizing the content items on the display of the device along a continuum, wherein more contextually relevant content is located closer to a center area of the display and less contextually relevant content is located away from the center area.

### BRIEF DESCRIPTION OF THE DRAWINGS

The foregoing aspects and other features of the embodiments are explained in the following description, taken in connection with the accompanying drawings, wherein:

FIG. 1 is a block diagram of a user interface incorporating aspects of the disclosed embodiments;

FIG. 2 is a block diagram of an exemplary user interface incorporating aspects of the disclosed embodiments;

FIG. 3 illustrates a series of screen shots of an exemplary user interface incorporating aspects of the disclosed embodiments;

FIG. 4 is a block diagram of a system in which aspects of the disclosed embodiments may be applied;

FIG. 5 is an exemplary process flow diagram incorporating aspects of the disclosed embodiments;

FIGS. 6A and 6B are illustrations of exemplary devices that can be used to practice aspects of the disclosed embodiments;

FIG. 7 illustrates a block diagram of an exemplary system incorporating features that may be used to practice aspects of the disclosed embodiments; and

FIG. 8 is a block diagram illustrating the general architecture of an exemplary system in which the devices of FIGS. 6A and 6B may be used.

### DETAILED DESCRIPTION OF THE EMBODIMENT(s)

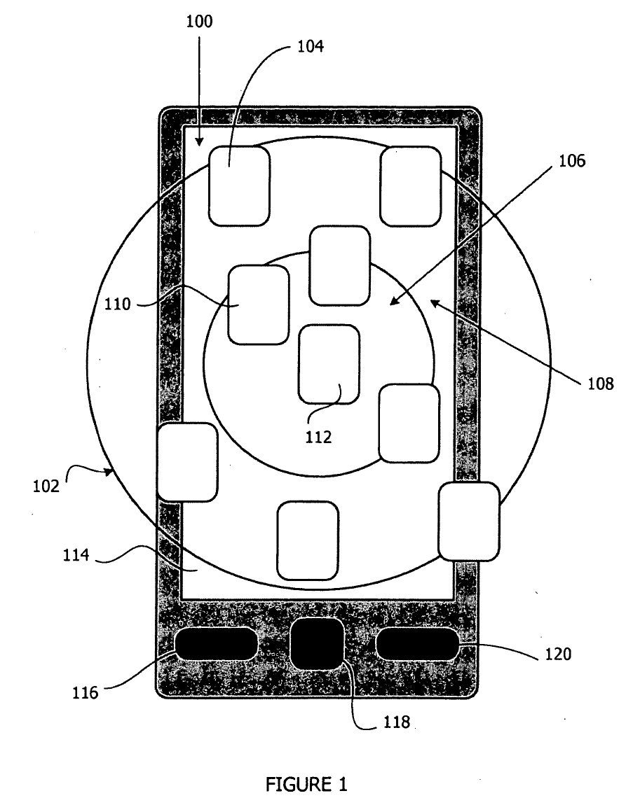

FIG. 1 illustrates an exemplary user interface 100 incorporating aspects of the disclosed embodiments. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments generally provide a user interface framework, the center of which is an adaptive view that includes contextually relevant content. More or highly contextually relevant content can be placed at or near the center region of the view. Less contextually relevant can be placed further out from the center region of the view. Users do not need to remember which applications are open or have been closed, are more or less often used, or are relevant to an active task, for example. The contextually relevant content view provides efficient, adaptive visualization and navigation to the services and contents most utilized and pertinent to the user.

FIG. 1 is an illustration of an exemplary user interface incorporating aspects of the disclosed embodiments. As shown in FIG. 1, the user interface 100 includes a contextually relevant content view 102. One or more icons or objects 104 can be displayed or presented in the contextually relevant content view 102. These icons or objects 104 are generally used to represent an underlying application, program, service, link, file, data, document, electronic mail program, notification program, electronic messaging program, a calendar application, a data processing application, a word processing application, gaming application, multimedia applications and messaging, an Internet based web-page or application, a telephone application or location based application, otherwise referred to herein as “content” or “content items.” This list is merely exemplary, and in alternative embodiments, the content can include any suitable content that can be found on an electronic device, such as for example, a mobile communication device or terminal. Although the objects 104 shown in FIG. 1 generally comprise a rectangular shape, in alternative embodiments, any suitable icon or object, as the term is generally understood, can be used.

The user interface 100 of the disclosed embodiments is generally configured to provide a view of content based upon the contextual relevance of the content. Contextual relevance can be determined by a number of factors, including, but not limited to location, time, device status (e.g. connected to a charger, Bluetooth™ active, silent profile, call active, currently open applications set, etc.) and any other information available from sensors of the device, such as device orientation, device in motion/static and temperature, for example. In one embodiment, the icons 104 are arranged within the view 102 according to the contextual relevance of the underlying content. As shown in FIG. 1, the icons 104 are grouped beginning in the approximate center region 106 of the view 102 and extending outwards towards and beyond the outer edges or boundaries of the display area 114. Icons for more contextually relevant content are positioned or located closer to the approximate center area 106 of the view 102. Icons for less contextually relevant content can be located farther away from the approximate center area 106. The icon for the most current content viewed (e.g. the last application or web page view prior to the current contextual view 102) can be located in the approximate center 112 of the view 102.

In a multitasking environment, one or more content items can be running, active or open at one time. In order to arrange the icons 104 in the view 102, a determination is made as to the contextual relevance of each content item. For example, open or active content can be considered more contextually relevant content. Often used or associated content, a messaging application that has recently received or un-opened notifications or messages, or an active web-page or an open data processing document can also be considered more contextually relevant content.

Less contextually relevant content can include for example, but are not limited to, applications that are open but have not been active for a certain period of time, applications that have recently been closed, or applications that are not related to an application that is currently active. In addition to open and recent applications, other contextually relevant content or items can include recent content, people, web pages, active notifications, location related information, a web page that is open, but has not been viewed for a certain period, or a messaging application that is active but does not have any current or new messages. In one embodiment, applications that are closed do not disappear from the view 102, but are rather placed, positioned or moved farther away from the approximate center 106, to for example in the region represented by area 108.

As shown in FIG. 1, the contextual relevance of an item is determines its position along a general continuum within the view 102, where more contextually relevant content is located closer to the approximate center region 106 of the view 102. The term “continuum” as used herein is not limited to a straight line, but can include a general, spatial or scattered ordering of content times, such as that shown in FIG. 1. In one embodiment, the content items could be displayed in a spiral fashion, with the most relevant content item in the middle of the view 102 and less relevant content items extending out as arms along a radius.

As an item is positioned or moves away from the approximate center region 106, the contextual relevance of the item diminishes, relative to content that is closer to the approximate center region 106. In the example shown in FIG. 1, the items located closer to the approximate center 106, such as items 110 and 112, are considered to be more contextually relevant that the items located farther away from the approximate center region 106, such as item 104. In one embodiment, an example of a more contextually relevant content item is an open application, while a less contextually relevant content item is a recent application. For descriptive purposes here, the icons in the view 102 will be described in terms of content and content items. However, it will be understood, that the view will include links to the underlying content, and not necessarily the content themselves, the links comprising icons or objects, in accordance with the traditional meaning of these terms. The areas 106 and 108 are merely for descriptive purposes only, and the scope of the disclosed embodiments is not limited to a specific area, areas or zones. In the disclosed embodiments, the contextual relevance of an item is highlighted the position of the item relative to the approximate center region 106 of the view 102 and other items within the view.

In one embodiment, the user interface 100 can include one or more keys 116, 118 and 120. In alternate embodiments, the user interface 100 can include any number of keys or input devices, such as for example one or more soft keys (not shown). The contextually relevant content view can be activated upon activation of a key, such as one of keys 116, 118 or 120, activation of a soft key, or a menu command, for example. In alternate embodiments, any suitable mechanism can be used to activate or open the contextually relevant content view, such as for example, a voice input, a stroke on a touch screen device, a position of the device, movement of or shaking the device.

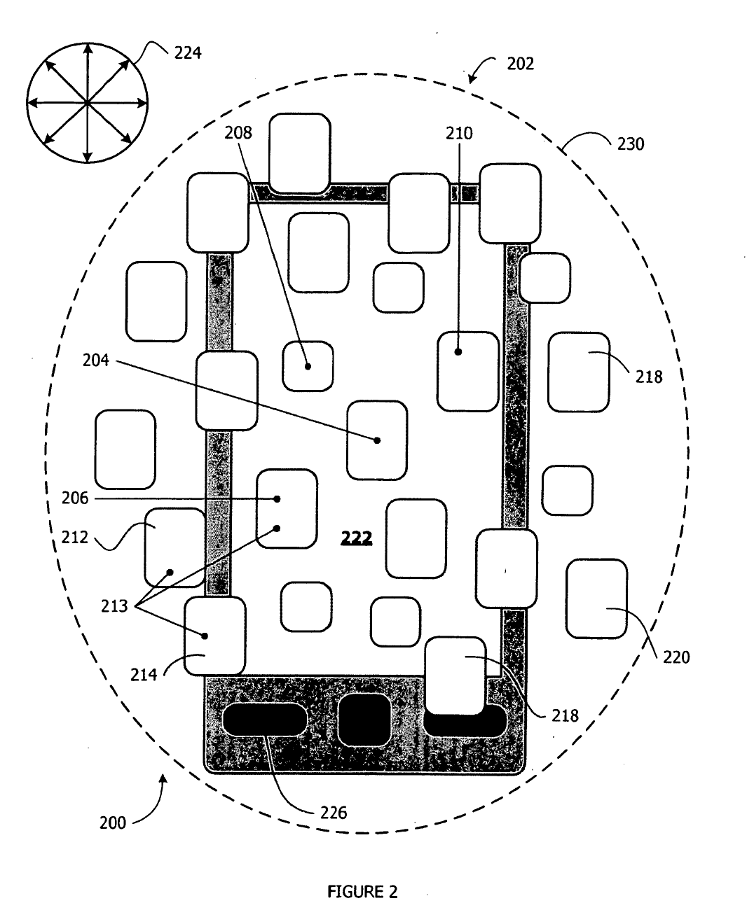

Referring to FIG. 2, another example of a user interface 200 incorporating aspects of the disclosed embodiments is illustrated. In this example, at least a portion of a relevance view 202 is displayed on the user interface 200. It is noted that due to the limited size of the display area 222 of the user interface 200, only a portion of the view 202 is visible on the display area 222. The relevance view 202 includes a plurality of icons representing contextually relevant content. In one embodiment, the icons can be grouped together as what is referred to herein as a contextual link “cloud.” The “cloud”, represented by the view 202, will generally fill the display area 222, where one or more icons may partially or fully extend out of the display area 222. In one embodiment, each icon within the cloud can be configured to drift or flutter, as if blowing in the wind. Tapping or selecting a specific icon can open the item directly. Selecting and dragging an icon within the display area 222 can move the entire cloud link, i.e. all of the icons in substantial unison. In one embodiment, when one icon is selected and dragged, the other icons can follow, but with a pre-determined delay. This can give the impression that the icons are being dragged across or about the display area 222. Items that are not currently visible within the display area 222, as they are further away from the center 204 of the view 202, can be moved within the display area 222. In one embodiment, the center 204 of the view 202 can be highlighted, so that the center of the view is readily apparent, even when the center of the view 202 does not coincide with the center area of the display 222. This allows the user to pan the view 202 around and visualize all of the content items within the view 202 on the display area 222. The view 202 can be moved or panned in any suitable direction. In one embodiment, icons that are only partially or not visible in the display area 222 can intermittently or periodically move into and then out of the display area 222. This can alert the user to the presence of these content items in the view 202, even though they are not within the display area 222. The icons can be moved one at a time, a few or all at a time, or on a rotating basis.

Items within the view 202 can be opened or closed. In one embodiment, opening or closing an item can be executed by a long tap object menu or a long key press. The relevance view 202 can be closed by another press of the activation key, returning the user interface 200 to the state it was in before the relevance view was activated. In alternate embodiments, any suitable mechanism can be used to open and close an item within the view 202, or the view 222 itself.

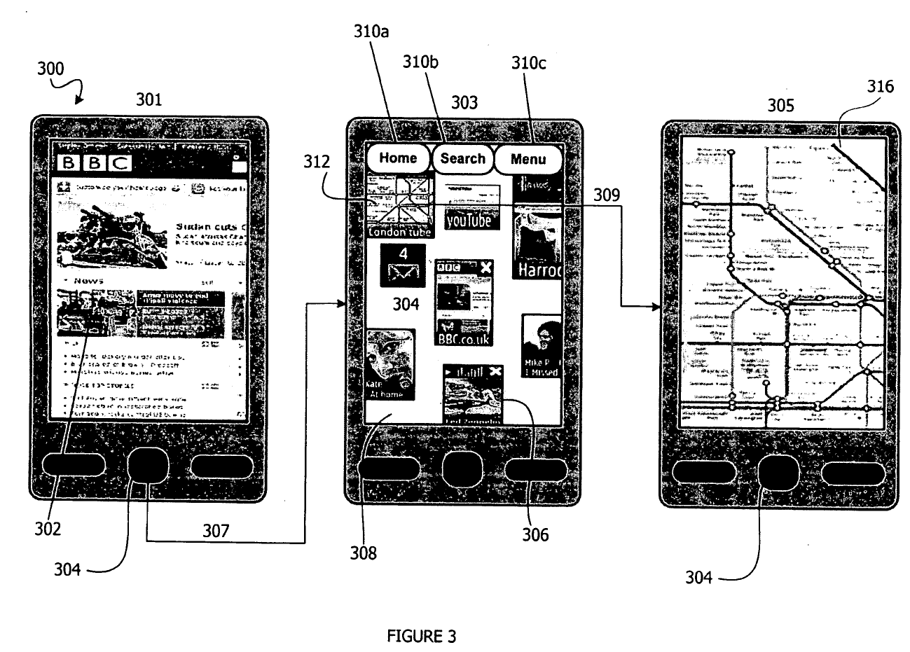

In the example shown in FIG. 2, the current foreground application 204 is presented in the substantial center of the relevance view 202. The current foreground application 204 can be considered the last state of the user interface 200 before the relevance view mode was activated. For example, referring to FIG. 3, in screen 301, a web page 302 for a news channel is the current state of the user interface 300. When the contextually relevant content mode is activated, the state of the user interface 300 changes to that shown in screen 303. The centermost icon 306 is representative of the web page 302 shown in screen 301, as it was the last active state of the user interface.

Referring again to FIG. 2, other contextually relevant content can be located near the center icon 204. For example, an open application 206 is located near, farther away from the center icon 204. An active notification 208 is also located near the center region, but away from the center icon 204. A recent application 210 is also farther out from the center icon 204, indicative of a less contextually relevant content item. As content moves farther away from the center region or center icon 204, it can be considered less relevant, relative to icons close to the center 204.

In one embodiment, associated or related items 213 can be located or grouped near each other within the view 202. In this example, the open application 206 is related to items 212 and 214. Thus, items 212 and 214 can be grouped near open application 206, to suggest the relationship or relevance to one another.

As can be seen from FIG. 2, there are more icons relating to contextually relevant content than can be displayed at any one time in the view 202, due to size limitations of the display area 222. Some icons, such as icons 210 and 214, are only partially visible within the display area 222 of the view 202. Icon 212, which is related to icon 206, is not visible on the view 202, because it falls outside the display area 222, even though it is included in the contextually relevant content view 202.

In order to be able to view all contextually relevant content, in one embodiment, the view 202 can be shifted or panned from right to left, top to bottom, or in any general direction, as shown generally by direction indicator 224. In one embodiment, a “select and drag” method can be used to shift all of the icons that comprise the view 202. Using a pointing device, or other cursor or navigation control device, any one of the icons in the display area 222 can be selected and held to move the entire frame 230 of the view 202. Although a shape of the frame 230 shown in FIG. 2 is generally circular, in alternate embodiments the shape can be any suitable shape. Using the select and drag method, the view 202 can be moved in any direction within the display area 222. Icons not previously visible can be moved into the visible display area 222. Icons that were visible can be moved outside the display area 222. For example, by moving the frame 230 to the right, icon 214 will come into view on the display area 222. A “select and drag” to the left, can cause icon 218 to come into view on the display area 222. Similarly, a select and drag in an upward direction will cause icon 218 to come into the display area 222. A select and drag to the left and in an upward direction can cause icon 220 to be presented in the display area 222. Generally, the view 202 can be moved in any direction on the user interface 200 so that all content items can be made visible at one time or another.

In the view 202, the open applications are not distinguished from other contextually relevant items, such as for example, recently closed applications, aside from their position in relation to the center of the view, or the center icon 204. In alternate embodiments, more contextually relevant content items could be highlighted or otherwise further distinguished from less contextually relevant content items. In one embodiment, open application items could be distinguished from closed applications by any suitable indicator or highlighting, such as for example, a flag, color, size, shape or movement of the icon. For example, open items may move or “flutter” relative to closed items.

The view 202 generally presents as a flat, non-hierarchical “contextual soup” view, where the most contextually relevant items are located closer to a center region of the view. This allows the most relevant content items, applications and services to be determined quickly and easily with a quick glance. In one embodiment, the view 202 can be presented in a three-dimensional manner, where contextually relevant content can be presented in a continuum along a z-axis. More contextually relevant content would be located or appear to be in the forefront of the three-dimensional view, while less contextually relevant content being positioned or moving away from the forefront or center of the view.

Referring again to FIG. 3, in screen 301 the current foreground application is the web page 302. In one embodiment, the contextually relevant content view 308, in screen 303 can be accessed by activation of key 304. Although the contextually relevant content view 308 is shown as occupying the entirety of the screen, in one embodiment, the view 308 can be provided as a separate view or state of the user interface 300. In an alternate embodiment, the view 308 can be included as a section or region of another screen of the user interface, such as for example, a home screen. In this example, a separate function or tool can be enabled to allow for a full screen view of the contextually relevant content view. In this embodiment, tools or other options can be provided to allow for the re-sizing of the view, to adjust to a size of a respective display area.

In one embodiment, the view 308 can also include menu launch icons 310a, 310b and 310c that can provide access to other functions of the device. In this example, the icons 310a-301c provide access to Home, Search and Menu functions of the device. In alternate embodiments, keys and activation, input or command mechanisms can be provided for any suitable functions. Context related search seeds and contextual results ordering can also be provided. The contextually related content is shown in the view 308.

Selection and activation of any one of the content icons shown in the view 308 can open the underlying application, if not already opened, and launch the corresponding view. In this example, a map application shown in the screen 303 is selected from the content icon 312 in the view 308. In one embodiment, the selection can comprise a short tap on the icon 312. In alternate embodiments, any suitable application or view launching method can be used. When the icon 312 is activated, the corresponding view is opened, as shown in screen 305. In this screen the content view 316 for the selected content 312 is shown. Selection or activation of the key 304 can revert the user interface to screen 303.

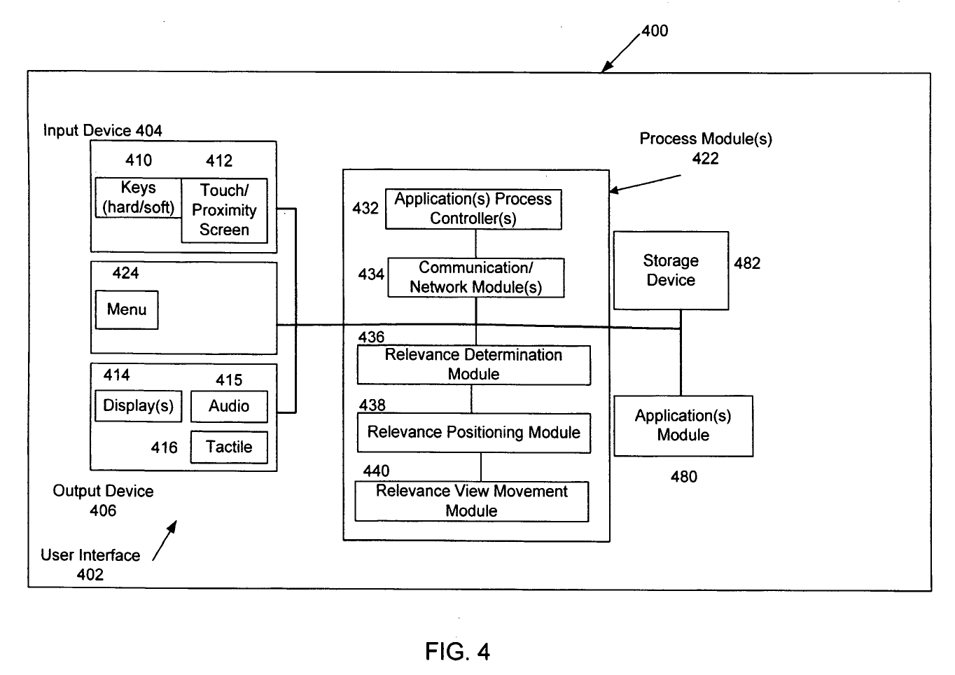

One embodiment of a system 400 incorporating aspects of the disclosed embodiments is shown in FIG. 4. In one embodiment, the system 400 shown in FIG. 4 can comprise a communications device, such as a mobile communications device. The system 400 can include an input device 404, output device 406, process modules 422, applications module 480 and storage device 482. The components described herein are merely exemplary and are not intended to encompass all components that can be included in the system 400. The system 400 can also include one or more processors or computer program products to execute the processes, methods, sequences, algorithms and instructions described herein.

In one embodiment the system 400 includes a relevance determination module 436. The relevance determination module 436 is generally configured to evaluate all content and rank content according to relevance. For example, open and active content can be ranked as more or highly relevant, while closed or inactive content can be ranked as less relevant. The relevance determination module 436 is generally configured to interface with, for example, the applications module 480 and application process controllers 432 to obtain the content data and information necessary for relevance determination. Relevance determination can be based upon pre-determined criteria, or also manually set by the user in an options configuration menu.

In one embodiment, the process module 422 can also include a relevance positioning module 438. The relevance positioning module 438 is generally configured to arrange and present or provide the contextually relevant content view, such as view 202 shown in FIG. 2, for display on the display 414. The spatial arrangement of icons, according to relevance determined by the module 436, in the view 202 will be determined by the relevance positioning module 438. In one embodiment, the relevance positioning module 438 can be configured to detect a size of a display area associated with the display 414. If the detected size corresponds to a small or limited size display area, the relevance positioning module 438 is configured to present the contextually relevant content view in accordance with the aspects of the disclosed embodiments described herein. If the detected size corresponds to a standard or large size display area, the relevance positioning module 438 can be configured to present the contextually relevant content view in a standard fashion or allow the user to choose between the different presentation and use options. For example, the contextually relevant content view can be configured to be a subset of a main page, or a pop-up window.

The system 400 can also include a relevance view movement module 440. As described herein, the view 202 shown in FIG. 2 is configured to be selected and dragged as a group, by selecting and moving any one of the icons that appear in the display area 222. In one embodiment, the relevance view movement module 440 is configured to identify all icons that belong to the context relevant view, and determine whether an action with respect to an icon is an activation action or a select and drag action. If a select and drag action is employed, the relevance view movement module 440 is configured to move all of the currently viewable icons out of the view 202, and bring icons outside of the view into the view, relatively in unison.,. The relevance view movement module 440 is configured to maintain the relative positioning of each icon within the view 202, and the select and drag operation is carried out. As described herein, the movement of each icon in the view can be varied or delayed to give the appearance of a push and pull action. Some icons might be caused to “flutter” while they are stationary or as they are moved. Other icons might be caused to stretch and contract as they are moved. In alternate embodiments, any suitable or desired action can be caused to take place to represent movement or repositioning of the icons. The actions can be pre-determined or manually set by the user in a options configuration menu. In one embodiment, the relevance view movement module 440 can also be configured to cause the less contextually relevant content icons to rotate or move around the most contextually relevant content item. The movement can be ordered or random. In the example shown in FIG. 2, the center icon 204 could remain stationary, while the other content icons move, or float, around the center icon 204. Icons not currently in the display view 222 could move into the view 222, while still preserving the contextually relevant view.

The input device(s) 404 are generally configured to allow a user to input data, instructions and commands to the system 400. In one embodiment, the input device 404 can be configured to receive input commands remotely or from another device that is not local to the system 400. The input device 404 can include devices such as, for example, keys 410, touch screen 412, menu 424, a camera device 425 or such other image capturing system. In alternate embodiments the input device can comprise any suitable device(s) or means that allows or provides for the input and capture of data, information and/or instructions to a device, as described herein. The output device(s) 406 are configured to allow information and data to be presented to the user via the user interface 402 of the system 400 and can include one or more devices such as, for example, a display 414, audio device 415 or tactile output device 416. In one embodiment, the output device 406 can be configured to transmit output information to another device, which can be remote from the system 400. While the input device 404 and output device 406 are shown as separate devices, in one embodiment, the input device 404 and output device 406 can be combined into a single device, and be part of and form, the user interface 402. The user interface 402 can be used to receive and display information pertaining to content, objects and targets, as will be described below. While certain devices are shown in FIG. 4, the scope of the disclosed embodiments is not limited by any one or more of these devices, and an exemplary embodiment can include, or exclude, one or more devices. For example, in one exemplary embodiment, the system 400 may not include a display or only provide a limited display, and the input devices, or application opening or activation function, may be limited to the key 408a of the headset device.

The process module 422 is generally configured to execute the processes and methods of the disclosed embodiments. The application process controller 432 can be configured to interface with the applications module 480, for example, and execute applications processes with respects to the other modules of the system 400. In one embodiment the applications module 480 is configured to interface with applications that are stored either locally to or remote from the system 400 and/or web-based applications. The applications module 480 can include any one of a variety of applications that may be installed, configured or accessible by the system 400, such as for example, office, business, media players and multimedia applications, web browsers and maps. In alternate embodiments, the applications module 480 can include any suitable application. The communication module 434 shown in FIG. 4 is generally configured to allow the device to receive and send communications and messages, such as text messages, chat messages, multimedia messages, video and email, for example. The communications module 434 is also configured to receive information, data and communications from other devices and systems.

In one embodiment, the system 400 can also include a voice recognition system 442 that includes a text-to-speech module that allows the user to receive and input voice commands, prompts and instructions.

The user interface 402 of FIG. 4 can also include menu systems 424 coupled to the processing module 422 for allowing user input and commands. The processing module 422 provides for the control of certain processes of the system 400 including, but not limited to the controls for selecting files and objects, accessing and opening forms, and entering and viewing data in the forms in accordance with the disclosed embodiments. The menu system 424 can provide for the selection of different tools and application options related to the applications or programs running on the system 400 in accordance with the disclosed embodiments. In the embodiments disclosed herein, the process module 422 receives certain inputs, such as for example, signals, transmissions, instructions or commands related to the functions of the system 400, such as messages, notifications and state change requests. Depending on the inputs, the process module 422 interprets the commands and directs the process control 432 to execute the commands accordingly in conjunction with the other modules, such as relevance determination module 436, relevance positioning module 438 and relevance view movement module 440.

Referring to FIG. 4, in one embodiment, the user interface of the disclosed embodiments can be implemented on or in a device that includes a touch screen display, proximity screen device or other graphical user interface. Although a display associated with the system 400, it will be understood that a display is not essential to the user interface of the disclosed embodiments. In an exemplary embodiment, the display is limited or not available. In alternate embodiments, the aspects of the user interface disclosed herein could be embodied on any suitable device that will allow the selection and activation of applications or system content when a display is not present.

In one embodiment, the display 414 can be integral to the system 400. In alternate embodiments the display may be a peripheral display connected or coupled to the system 400. A pointing device, such as for example, a stylus, pen or simply the user's finger may be used with the display 414. In alternate embodiments any suitable pointing device may be used. In other alternate embodiments, the display may be any suitable display, such as for example a flat display 414 that is typically made of a liquid crystal display (LCD) with optional back lighting, such as a thin film transistor (TFT) matrix capable of displaying color images.

The terms “select”, “touch” and “tap” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 410 of the system or through voice commands via voice recognition features of the system.

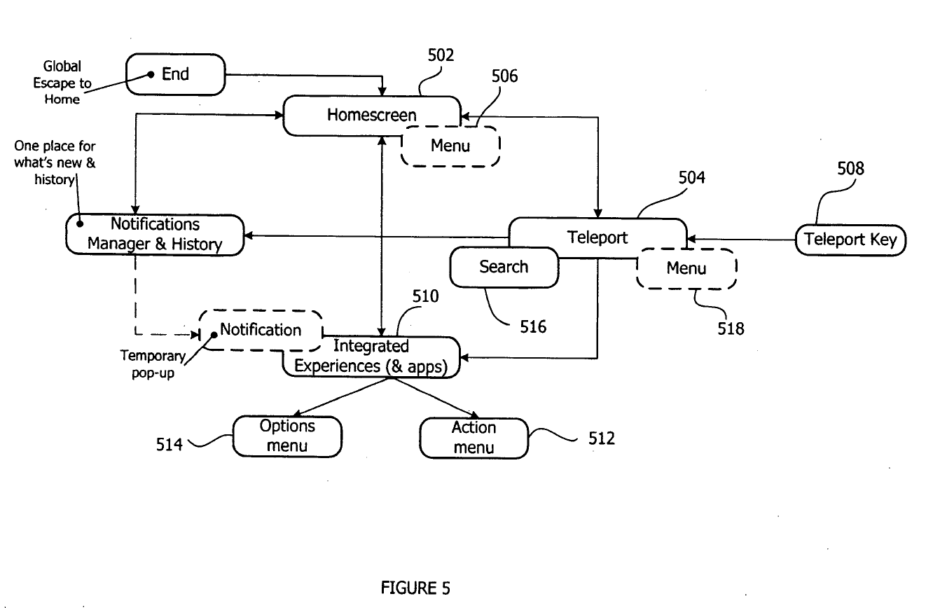

FIG. 5 illustrates one example of a process flow incorporating aspects of the disclosed embodiments. From a homescreen 502, or other state of the user interface, the user can access the context relevant content view 504. This can be achieved by accessing a menu 506, or activating a designated key 508. In one embodiment, when the context relevant content view 504 is activated, the relevance of each content item can be determined and presented on the display of the device in a pre-determined configuration, based on relevance. From the context relevant content view 504, the displayed content 510 can be accessed and activated. Actions can be taken with respect to the displayed content, such as opening a content item or moving the view to display further content items. Search 516 and menu 518 options can be provided that allow the user to navigate in the context relevant content and take certain actions. In one embodiment, an options menu can be accessed that can provide other search items or actions. For example, if an item cannot be found from the context relevant content view, the navigation flow can continue to the main menu by activating menu 518, or the item can be searched for by activating search 516.

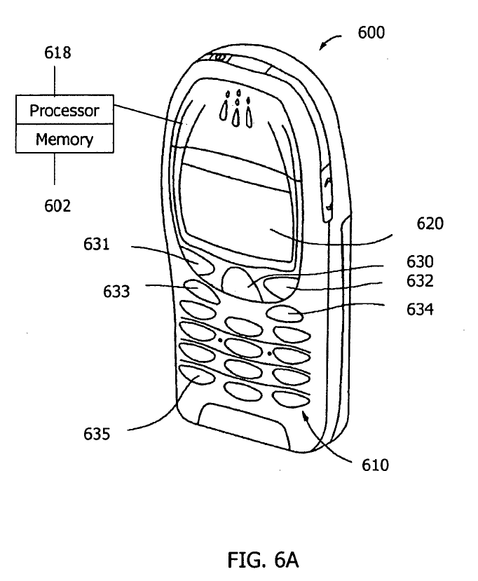

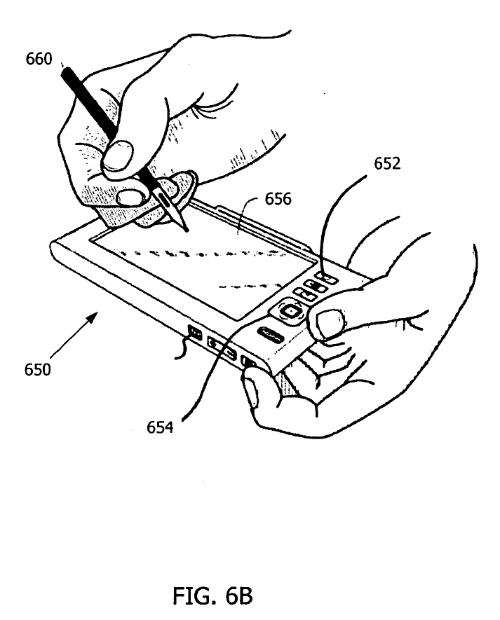

Some examples of devices on which aspects of the disclosed embodiments can be practiced are illustrated with respect to FIGS. 6A-6B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

FIG. 6A illustrates one example of a device 600 that can be used to practice aspects of the disclosed embodiments. As shown in FIG. 6A, in one embodiment, the 600 may have a keypad 610 as an input device and a display 620 for an output device. The keypad 610 may include any suitable user input devices such as, for example, a multi-function/scroll key 630, soft keys 631, 632, a call key 633, an end call key 634 and alphanumeric keys 635. In one embodiment, the device 600 can include an image capture device such as a camera (not shown) as a further input device. The display 620 may be any suitable display, such as for example, a touch screen display or graphical user interface. The display may be integral to the device 600 or the display may be a peripheral display connected or coupled to the device 600. A pointing device, such as for example, a stylus, pen or simply the user's finger may be used in conjunction with the display 620 for cursor movement, menu selection and other input and commands. In alternate embodiments any suitable pointing or touch device, or other navigation control may be used. In other alternate embodiments, the display may be a conventional display. The device 600 may also include other suitable features such as, for example a loud speaker, tactile feedback devices or connectivity port. The mobile communications device may have a processor 618 connected or coupled to the display for processing user inputs and displaying information on the display 620. A memory 602 may be connected to the processor 618 for storing any suitable information, data, settings and/or applications associated with the mobile communications device 600.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 100 of FIG. 1 may be for example, a personal digital assistant (PDA) style device 650 illustrated in FIG. 6B. The personal digital assistant 650 may have a keypad 652, cursor control 654, a touch screen display 656, and a pointing device 660 for use on the touch screen display 656. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display 414 shown in FIG. 4, and supported electronics such as the processor 618 and memory 602 of FIG. 6A. In one embodiment, these devices will be Internet enabled and include GPS and map capabilities and functions.

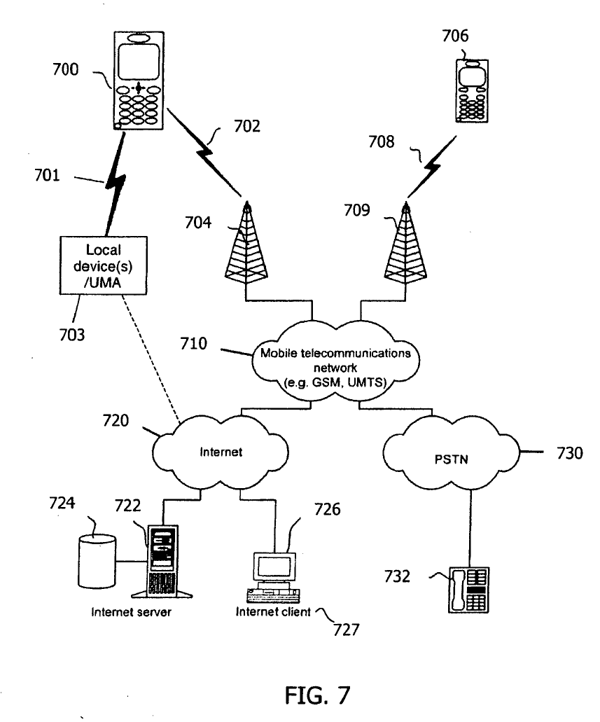

In the embodiment where the device 600 comprises a mobile communications device, the device can be adapted for communication in a telecommunication system, such as that shown in FIG. 7. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 700 and other devices, such as another mobile terminal 706, a line telephone 732, a personal computer 726 and/or an internet server 722.

In one embodiment the system is configured to enable any one or combination of chat messaging, instant messaging, text messaging and/or electronic mail. It is to be noted that for different embodiments of the mobile device or terminal 700, and in different situations, some of the telecommunications services indicated above may or may not be available. The aspects of the disclosed embodiments are not limited to any particular set of services or communication, protocol or language in this respect.

The mobile terminals 700, 706 may be connected to a mobile telecommunications network 710 through radio frequency (RF) links 702, 708 via base stations 704, 709. The mobile telecommunications network 710 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 710 may be operatively connected to a wide-area network 720, which may be the Internet or a part thereof. An Internet server 722 has data storage 724 and is connected to the wide area network 720, as is an Internet client 727. The server 722 may host a worldwide web/wireless application protocol server capable of serving worldwide web/wireless application protocol content to the mobile terminal 700. The mobile terminal 700 can also be coupled via link 742 to the internet 720′. In one embodiment, link 742 can comprise a wired or wireless link, such as a Universal Serial Bus (USB) or Bluetooth™ connection, for example.

A public switched telephone network (PSTN) 730 may be connected to the mobile telecommunications network 710 in a familiar manner. Various telephone terminals, including the stationary telephone 732, may be connected to the public switched telephone network 730.

The mobile terminal 700 is also capable of communicating locally via a local link 701 to one or more local devices 703. The local links 701 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 703 can, for example, be various sensors that can communicate measurement values or other signals to the mobile terminal 700 over the local link 701. The above examples are not intended to be limiting, and any suitable type of link or short range communication protocol may be utilized. The local devices 703 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 700 may thus have multi-radio capability for connecting wirelessly using mobile communications network 710, wireless local area network or both. Communication with the mobile telecommunications network 710 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 422 of FIG. 4 includes communication module 434 that is configured to interact with, and communicate with, the system described with respect to FIG. 7.

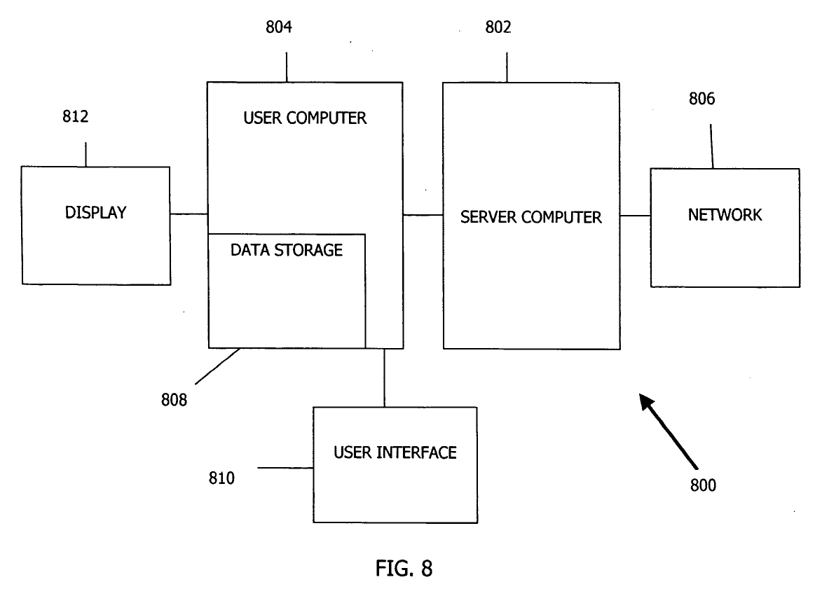

The disclosed embodiments may also include software and computer programs incorporating the process steps and instructions described above. In one embodiment, the programs incorporating the process steps described herein can be executed in one or more computers. FIG. 8 is a block diagram of one embodiment of a typical apparatus 800 incorporating features that may be used to practice aspects of the invention. The apparatus 800 can include computer readable program code means for carrying out and executing the process steps described herein. In one embodiment the computer readable program code is stored in a memory of the device. In alternate embodiments the computer readable program code can be stored in memory or memory medium that is external to, or remote from, the apparatus 800. The memory can be direct coupled or wireless coupled to the apparatus 800. As shown, a computer system 802 may be linked to another computer system 804, such that the computers 802 and 804 are capable of sending information to each other and receiving information from each other. In one embodiment, computer system 802 could include a server computer adapted to communicate with a network 806. Alternatively, where only one computer system is used, such as computer 804, computer 804 will be configured to communicate with and interact with the network 806. Computer systems 802 and 804 can be linked together in any conventional manner including, for example, a modem, wireless, hard wire connection, or fiber optic link. Generally, information can be made available to both computer systems 802 and 804 using a communication protocol typically sent over a communication channel or other suitable connection or line, communication channel or link. In one embodiment, the communication channel comprises a suitable broad-band communication channel. Computers 802 and 804 are generally adapted to utilize program storage devices embodying machine-readable program source code, which is adapted to cause the computers 802 and 804 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 802 and 804 may also include a microprocessor for executing stored programs. Computer 802 may include a data storage device 808 on its program storage device for the storage of information and data. The computer program or software incorporating the processes and method steps incorporating aspects of the disclosed embodiments may be stored in one or more computers 802 and 804 on an otherwise conventional program storage device. In one embodiment, computers 802 and 804 may include a user interface 810, and/or a display interface 812 from which aspects of the invention can be accessed. The user interface 810 and the display interface 812, which in one embodiment can comprise a single interface, can be adapted to allow the input of queries and commands to the system, as well as present the results of the commands and queries, as described with reference to FIG. 1, for example.

The aspects of the disclosed embodiments generally provide a user interface framework, including an adaptive view that includes contextually relevant content. More or highly contextually relevant content can be placed at or near the center region of the view. Less contextually relevant content is located farther out or away from the center of the view and relative to other content items. Users do not need to remember which applications are open or have been closed, are more or less often used, or are relevant to an active task, for example. The contextually relevant content view provides efficient, adaptive visualization and navigation to the services and contents most utilized and pertinent to the user.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
providing content items to be displayed on a display of a device;
determining a relevance of each content item with respect to each other content item; and
organizing the content items on the display of the device along a continuum, wherein more contextually relevant content is located closer to a center area of the display and less contextually relevant content is located away from the center area.

2. The method of claim 1 further comprising:
detecting an activation of a contextually relevant content view function; and
changing a view on the display from a current content view to the contextually relevant content view.

3. The method of claim 1 wherein more contextually relevant content comprises open applications, active notifications and location related information and less contextually relevant content comprises recent applications, recent content, people and webpages.

4. The method of claim 1 further comprising configuring more contextually relevant content in a concentric manner around a center region of the display, and less contextually relevant content around the more contextually relevant content.

5. The method of claim 1 further comprising that more contextually relevant content is highlighted in relation to less contextually relevant content.

6. The method of claim 1 further comprising marking open applications as more contextually relevant content and marking recently closed applications as less contextually relevant content.

7. The method of claim 1 further comprising enabling selection of any one of a more contextually relevant content item or less contextually relevant content item, and opening an active view to a selected more contextually relevant content item or less contextually relevant content item.

8. The method of claim 7 further comprising that selection of a more contextually relevant content opens the active view of a corresponding application and selection of a less contextually relevant content opens a corresponding application.

9. The method of claim 1 further comprising detecting a closing of a more contextually relevant content item, reclassifying the closed content item as a less contextually relevant content, and re-positioning the reclassified content to a point farther away from the center area.

10. The method of claim 1 further comprising identifying related content on the display and grouping related content in close proximity to each other.

11. The method of claim 1 further comprising that a most currently active application is represented by an application icon located in an approximate center of a display area.

12. The method of claim 1 further comprising continuously rotating each of the content items in and out of the view, to bring content items not currently in a view of the display into the view.

13. An apparatus comprising:
a display;
at least one processor configured to run at least one content item and present the at least one content item on the display;
a relevance determination module configured to determine a relevance of the at least one content item relative to at least one other content item; and
a relevance positioning module configured to align each content item along a general continuum based upon the determined relevance, where more contextually relevant content is positioned closer to a center area of a view on the display than less contextually relevant content.

14. The apparatus of claim 13 further comprising a contextual relevance content activation device that is configured to, when activated, generate a contextually relevant content view wherein a last state of the apparatus comprises a most contextually relevant content item and is positioned by the relevance positioning module in a center of the view.

15. The apparatus of claim 13 further comprising a relevance view movement module configured to pan all content items in the view in and out of the display area relative to a movement of a currently displayed content item that is selected and moved about the display area.

16. The apparatus of claim 13 further comprising a marking module configured mark all content items depending upon the determined relevance, and cause each displayed content item to flutter at a frequency that varies in relation to the determined relevance.

17. A user interface comprising:
a first content item presented on a display of the user interface, the first content item be designated as a most contextually relevant content item and positioned in an approximate center area of a view including a plurality of contextually relevant content items; and
at least one other content item presented on a display of the user interface, the at least one other content item being positioned along a scattered continuum of contextually relevant content items, wherein more contextually relevant content items are positioned closer to the first content item and less contextually relevant content items are positioned farther away from the first content item.

18. The user interface of claim 17 further comprising that the first content item is a link to a last view state of a device prior to activation of a contextual relevant content view mode.

19. The user interface of claim 17 further comprising that the first content item and the at least one other content item are movable, and wherein the view including a plurality of contextually relevant content items can be re-positioned to bring contextually relevant content items not currently in a viewing area of the display into the viewing area.

20. A computer program product comprising computer readable code means stored in a memory, the computer program product being configured to execute the method steps according to claim 1.
